(19) United States
(12) Patent Application Publication
(10) Pub. No.: US 2008/0245963 A1
(43) Pub. Date: Oct. 9, 2008

(54) Method and Apparatus for Generation of Reagent Ions in a Mass Spectrometer

(76) Inventors: Adrian Land, San Carlos, CA (US); Lee Earley, Mountain View, CA (US); George C. Stafford, San Jose, CA (US)

Correspondence Address: THERMO FINNIGAN LLC, 355 RIVER OAKS PARKWAY, SAN JOSE, CA, 95134, US

(21) Appl. No.: 11/962,009

(22) Filed: Dec. 20, 2007

Related U.S. Application Data
(60) Provisional application No. 60/921,777, filed on Apr. 4, 2007.

(51) Int. Cl. H01J 49/14

(52) U.S. Cl. 250/288

(57) ABSTRACT

A front-end ion source for a mass spectrometer generates both analyte and reagent ions. The reagent source may include a heater for vaporizing a condensed-phase reagent substance and an electron source for ionizing reagent molecules. The interior of the reagent ionization chamber is purged with a purge gas to avoid or minimize reaction of the reagent ions with oxygen or other reactive species, thereby enabling operation of the reagent ionization chamber at or near atmospheric pressure. The reagent and analyte ions are directed into a reduced-pressure chamber through separate passageways. An ion transport optic selectively transmits one of the analyte ions or the reagent ions from the reduced-pressure chamber to downstream regions of the mass spectrometer.

### CROSS-REFERENCE TO RELATED APPLICATION

This application claims the priority benefit under 35 U.S.C. §119(e) of U.S. Provisional Patent Application No. 60/921,777 entitled “Method and Apparatus for Generation of ETD/PTR Reagent Ions” filed Apr. 4, 2007, the entire disclosure of which is incorporated herein by reference.

### FIELD OF THE INVENTION

The present invention relates generally to ion sources for mass spectrometry, and more particularly to an ion source for generating reagent ions for subsequent reaction with analyte ions.

### BACKGROUND OF THE INVENTION

Electron transfer dissociation (ETD) is a recently developed fragmentation technique for analysis of substances by MS/MS or MSⁿ mass spectrometry. In ETD, analyte ions are reacted under controlled conditions with reagent ions of opposite polarity. The transfer of electrons between reagent and analyte ions (from the reagent ion to the analyte ions for analyte cations) produces dissociation of the analyte ions. ETD is a particularly useful tool for proteomics research, since it yields information complementary to that obtained by conventional dissociation techniques (e.g., collisionally induced dissociation), and also because ETD fragmentation tends to generate fragment ions having intact post-translational modifications, such as phosphorylation.

Implementation of ETD in a mass spectrometer requires at least two separate ion sources: a first ion source for generating analyte ions from a sample, and a second ion source for generating reagent ions. Typically, the analyte ion source utilizes an ionization technique, such as electrospray ionization, that operates at atmospheric pressure. In contrast, atmospheric-pressure ionization techniques have generally not been employed to produce reagent ions, due to a widely-held belief that the fragile reagent ions would not survive in such an environment. Instead, techniques that generate reagent ions at low pressures have been employed. In one example of an ETD implementation, embodied in the ETD option for the Thermo Scientific LTQ XL linear ion trap mass spectrometer (San Jose, Calif.), the analyte ions are generated in an electrospray source and delivered through a first set of ion transport optics to the front end of a linear ion trap mass analyzer, and the reagent ions are generated in a chemical ionization source and delivered through a second set of ion transport optics to the back end of the ion trap. While such an arrangement is successful for its intended purpose, the production of reagent ions in a vacuum ion source and delivery through dedicated ion transport optics to the back end of the trap makes the instrument bulkier and significantly raises manufacturing costs, and also renders more cumbersome the incorporation of additional components (e.g., a second mass analyzer) downstream of the ion trap.

### SUMMARY

Roughly described, an analyte/reagent ion source constructed in accordance with an embodiment of the invention includes an analyte ionization chamber for generating analyte ions from a sample, and a reagent ionization chamber for generating reagent ions (e.g., ETD reagent ions) having a polarity opposite to the analyte ions. The reagent ionization chamber is separate from the analyte ionization chamber and has a gas inlet connectable to a source of a purge gas to allow continuous purging of the internal volume of the ionization chamber. The reagent ionization chamber may include a heater for evaporating a reagent substance in liquid or solid form to produce gas-phase reagent molecules, and an electron source, such as a corona needle, for ionizing the reagent molecules. In a typical implementation, generation of reagent ions takes place at or near atmospheric pressure, but operation at superatmospheric or subatmospheric pressure is also possible. Reagent ions flow through a first ion passageway, which may take the form of an elongated capillary, into a reduced-pressure chamber. The analyte ions produced in the analyte ionization chamber flow through a second passageway, which may also be implemented as an elongated capillary, into the reduced-pressure chamber. Selective transmission of either the reagent ions or the analyte ions into downstream regions of the mass spectrometer may be accomplished by adjusting the polarity and/or magnitude of voltages applied to one or more ion transport optics.

By generating the reagent ions in a relatively high-pressure region located at the front end of the mass spectrometer, embodiments of the present invention avoid the need to provide dedicated reagent ion transport optics, as well as other disadvantages associated with a back-end reagent ion source.

### BRIEF DESCRIPTION OF THE FIGURE

In the accompanying drawing:

FIG. 1 is a symbolic diagram of a mass spectrometer incorporating a front-end reagent source, in accordance with an illustrative embodiment of the invention.

### DESCRIPTION OF ILLUSTRATIVE EMBODIMENT

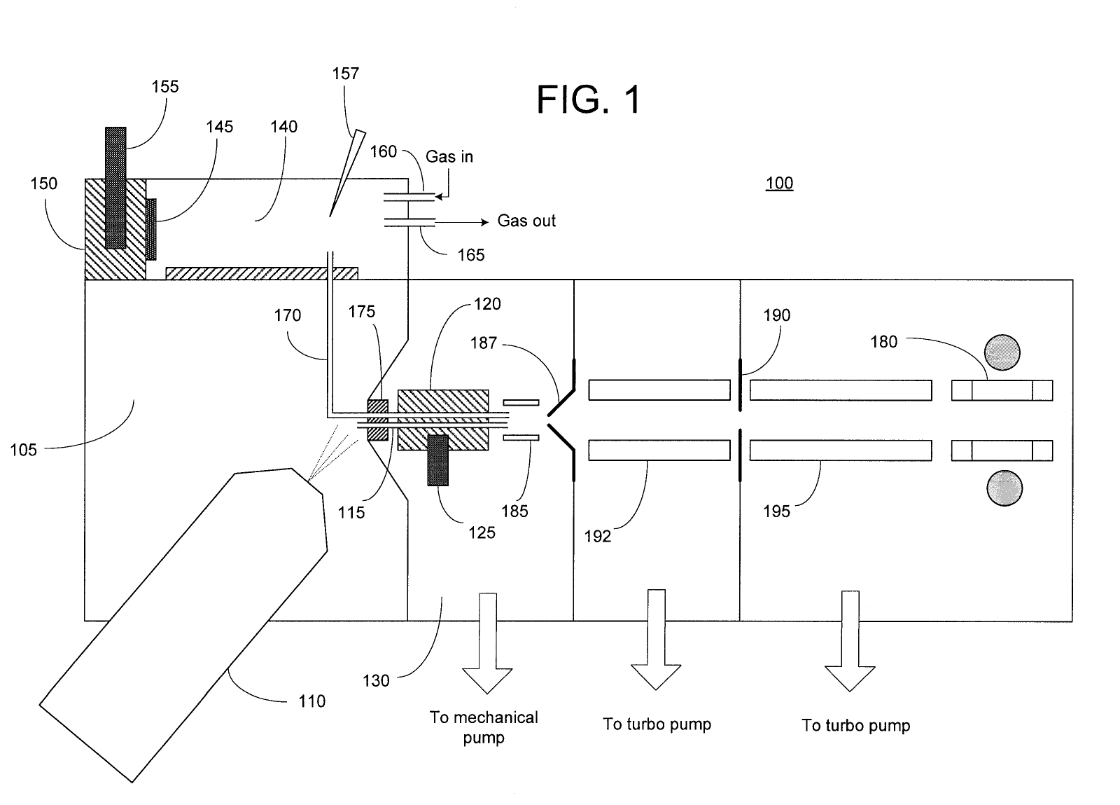

FIG. 1 schematically depicts a mass spectrometer 100 incorporating an ETD reagent source according to an embodiment of the present invention. Analyte ions (typically multiply-charged cations) are formed by electrospraying a sample solution into an ionization chamber 105 via an electrospray probe 110. Ionization chamber 105 will generally be maintained at or near atmospheric pressure. The analyte ions, together with background gas and partially desolvated droplets, flow into the inlet end of a conventional ion transfer tube 115 (a narrow-bore capillary tube) and traverse the length of the tube under the influence of a pressure gradient. Analyte ion transfer tube 115 is preferably held in good thermal contact with a block 120 that is heated by cartridge heater 125. As is known in the art, heating of the ion/gas stream passing through analyte ion transfer tube 115 assists in the evaporation of residual solvent and increases the number of analyte ions available for measurement. The analyte ions emerge from the outlet end of analyte ion transfer tube 115, which opens to reduced-pressure chamber 130. As indicated by the arrow, chamber 130 is evacuated to a sub-atmospheric pressure (typically around 0.5-10 Torr) by a mechanical pump or equivalent.

To produce the requisite reagent ions (having a polarity opposite to that of the analyte ions), a reagent ionization chamber 140 is provided having located therein a volume of a reagent substance 145 (e.g., fluoranthene for ETD reagent ions or benzoic acid for PTR reagent ions) in condensed-phase (solid or liquid) form. Reagent substance 145 is placed in thermal contact with a block 150 heated by a cartridge heater 155. The reagent vapor pressure within chamber 140 is regulated by controlling the temperature (via adjusting power supplied to heater 155) of block 150. A corona needle 157 (or similar source of electrons, such as a cold cathode, radioisotope (e.g., Ni⁶³), photoelectron source, or Townsend discharge) emits electrons to ionize the reagent molecules. A gas inlet 160 opening to the interior of chamber 140 enables continuous purging of chamber 140 with an purge gas (which may take the form of one or a combination of inert gases such as nitrogen, helium or argon, or a suitable non-inert gas, such as methane) to prevent the destruction of reagent ions occurring by reaction with oxygen or other undesirable gas species. An optional gas outlet 165 may be provided to allow continuous removal of a portion of the purge gas. Provided that oxygen and other gases that destroy or significantly inhibit the formation of the reagent ions are excluded, the interior of chamber 140 may be maintained at or near atmospheric pressure without excessive reagent ion losses.

In a variation of the reagent ionization chamber described above, the reagent evaporation and ionization functions may be separately conducted in two chambers or regions (a reagent evaporation chamber and a reagent ionization chamber) divided by a wall or other partition. The partition is adapted with an aperture or equivalent passageway permitting the flow of reagent vapor molecules produced in the evaporation chamber to the ionization chamber. This arrangement provides the advantage of enabling independent optimization of the conditions (e.g., pressure and temperature) at which the evaporation and ionization processes occur. It has been found, for example, that efficient production of fluoranthene ions is achieved when the evaporation chamber is maintained at a temperature of about 120° C., while the ionization chamber is maintained at a temperature of about 275° C.

While the interior volume of ionization chamber 140 will typically be held at or near atmospheric pressure, embodiments of the invention should not be construed as limited to atmospheric pressure operation. In certain implementations, it may be advantageous to maintain ionization chamber 140 at a pressure substantially above or below atmospheric pressure. It is noted, however, that the pressure of ionization chamber 140 will need to be elevated relative to the pressure within reduced-pressure chamber 130 to establish a pressure gradient that results in the forward flow of reagent ions through ion transfer tube 170.

Reagent ions (together with some of the added inert gas) enter an inlet end of reagent ion transfer tube 170 and traverse the length of the tube under the influence of a pressure gradient. A metallic grid or other structure may be placed at or near the inlet end of the ion transfer tube to inhibit entry of ions having a polarity opposite to the desired reagent ions (noting that a corona source may produce both positively and negatively-charged ions). Reagent ion transfer tube 170 is a narrow-bore capillary tube fabricated from a suitable material, which extends between the interior of reagent ionization chamber 140 and reduced pressure-chamber 130. Reagent ion transfer tube 170 and analyte ion transfer tube 115 may pass through a ferrule 175 or similar structure which seals ionization chamber 105 from reduced-pressure chamber 130. Reagent ion transfer tube 170 may be placed in thermal contact with heater block 120 to prevent condensation of reagent material on the tube walls. The reagent ions leave the ion transfer tube from an outlet end opening to reduced-pressure chamber 130, the outlet end being positioned proximate to the outlet end of analyte ion transfer tube 115.

The analyte and reagent ion sources may be operated to provide a continuous supply of analyte and reagent ions into chamber 130. For ETD, the analyte and reagent ions are injected sequentially into an ion trapping structure, which may take the form of a two-dimensional quadrupole ion trap mass analyzer 180. Selection of the ions to be delivered to ion trap 180 (i.e., the analyte or reagent ions) may be accomplished by applying DC voltages of the appropriate magnitude and polarity to the various ion transport optics, such as tube lens 185, skimmer lens 187, plate lens 190, and RF multipole ion guides 192 and 195, such that only the analyte ions are delivered to ion trap 180 at a first set of applied DC voltages, and only the reagent ions are delivered at a second set of DC voltages. In certain implementations, one of the RF multipole ion guides of the ion transport optics (which may be constructed from a set of rod electrodes having square or rectangular cross-sections) may be made mass selective by adding a DC component to the applied RF voltages to filter ions outside of a specified mass-to-charge ratio to prevent the entry of undesirable ion species during the reagent ion injection period.

A notable feature of the foregoing embodiment is that the reagent and analyte ion flows are maintained separate and unmixed until they arrive at reduced-pressure chamber 130. The undesirable reaction of the reagent and analyte ions within chamber 130 may be controlled to an operationally acceptable amount by locating skimmer lens 187 at an appropriate distance from the outlets of the ion transfer tubes 115 and 170, such that mixing of the two ion streams is minimized.

It should be recognized that the selection of analyte or reagent ions for delivery to ion trap 180 may be accomplished using techniques other than the method outlined above, including but not limited to switching the ion beams on and off at the source by modulation of the voltages applied to electrospray probe 110 and/or corona needle 157, or gas flow switching at the inlets to the ion transfer tubes (e.g., by using a pulsed gas source that selectively allows or inhibits reagent or analyte ion flow into the corresponding ion transfer tube inlet).

It should also be recognized that although the FIG. 1 embodiment depicts a single reagent ion source, other embodiments may incorporate plural reagent ion sources, with each reagent source supplying a different ETD or PTR reagent. For example, an ion source for ETD experiments may be provided with an analyte ionization chamber, an ETD reagent ionization chamber, and a PTR reagent ionization chamber, each of which communicates with the reduced-pressure chamber via separate passageways. In such an embodiment, selection between or among the multiple reagent sources may be accomplished using the ion transfer optics, by switching the sources on and off, by gas flow switching, or by any other suitable technique.

What is claimed is:

1. A front-end analyte/reagent ion source for a mass spectrometer, comprising:
an analyte ionization chamber configured to generate analyte ions from a sample;
a reagent ionization chamber configured to generate reagent ions having a polarity opposite to the analyte ions, the reagent ionization chamber being separate from the analyte ionization chamber and having a gas inlet connectable to a source of a purge gas to allow continuous purging of the reagent ionization chamber;
a first ion passageway extending between the analyte ionization chamber and a reduced-pressure chamber; and
a second ion passageway, separate from the first ion passageway, extending between the reagent ionization chamber and the reduced-pressure chamber.

2. The ion source of claim 1, wherein the first and second ion passageways respectively comprise first and second elongated capillaries.

3. The ion source of claim 1, wherein the reagent ionization chamber includes an electron source for producing electrons to ionize a reagent gas.

4. The ion source of claim 3, wherein the electron source includes a corona needle.

5. The ion source of claim 3, wherein the electron source includes a cold cathode.

6. The ion source of claim 3, wherein the electron source comprises a Townsend discharge.

7. The ion source of claim 1, further comprising an evaporation chamber having a heater for evaporating reagent gas from a condensed-phase volume of a reagent substance.

8. The ion source of claim 7, including a partition separating the evaporation and reagent ionization chambers, the partition being adapted with an aperture to permit the reagent gas to flow into the reagent ionization chamber.

9. The ion source of claim 1, further comprising:
at least one ion transport optic for selectively transmitting one of the analyte ions or the reagent ions into a downstream region of the mass spectrometer.

10. The ion source of claim 1, wherein the reagent ionization chamber is maintained at atmospheric pressure during operation of the mass spectrometer.

11. The ion source of claim 1, further comprising:
a second reagent ionization chamber configured to generate reagent ions having a polarity opposite to the analyte ions; and
a third passageway, separate from the first and second passageways, extending between the second reagent ionization chamber and the reduced-pressure chamber.

12. A mass spectrometer, comprising:
an analyte ionization chamber configured to generate analyte ions from a sample;
a reagent ionization chamber configured to generate reagent ions having a polarity opposite to the analyte ions, the reagent ionization chamber being separate from the analyte ionization chamber and having a gas inlet connectable to a gas source to allow continuous purging of the ionization chamber;
a first ion passageway extending between the analyte ionization chamber and the a reduced-pressure chamber;
a second ion passageway, separate from the first ion passageway, extending between the reagent ionization chamber and the interior volume of the first reduced-pressure chamber;
a mass analyzer located in a region of the mass spectrometer downstream in the ion path from the reduced-pressure chamber;
at least one ion transport optic for selectively transmitting one of the analyte ions or the reagent ions on an ion path leading to the mass analyzer.

13. The mass spectrometer of claim 12, wherein the mass analyzer includes an ion trap.

14. The mass spectrometer of claim 12, wherein the at least one ion transport optic is mass selective.

15. The mass spectrometer of claim 14, wherein the at least one ion transport optic comprises a multipole structure having rod electrodes with a square or rectangular cross section.

16. A method for providing analyte and reagent ions in a mass spectrometer, comprising:
generating analyte ions in an analyte ionization chamber;
generating reagent ions in a reagent ionization chamber separate from the analyte ionization chamber, the reagent ions having a polarity opposite to the analyte ions;
purging the reagent ionization chamber with a purge gas;
directing the analyte ions through a first passageway into a reduced-pressure chamber;
directing the reagent ions through a second passageway into the reduced-pressure chamber, the first and second passageways being separated such that the analyte ions and reagent ions are unmixed prior to their introduction into the reduced-pressure chamber;
transmitting a selected one of the reagent ions or the analyte ions from the reduced-pressure chamber to a downstream chamber of the mass spectrometer.

17. The method of claim 16, wherein the step of generating reagent ions includes heating a condensed-phase reagent substance to produce molecules of reagent gas.

18. The method of claim 17, wherein the step of generating reagent ions includes producing electrons to ionize the reagent gas.

19. The method of claim 17, wherein the step of heating the condensed-phase reagent substance is performed in an evaporation chamber maintained at a temperature different from the temperature of the reagent ionization chamber.

20. The method of claim 16, wherein the purge gas is nitrogen.

21. The method of claim 16, wherein the reagent ionization chamber is maintained at or near atmospheric pressure.

22. The method of claim 16, wherein the reagent ionization chamber is maintained substantially below atmospheric pressure.

23. The method of claim 22, wherein the reduced-pressure chamber is maintained at a pressure between 0.5-10 torr.

24. The method of claim 16, wherein the reagent ions are ETD reagent ions.

25. The method of claim 24, wherein the ETD reagent ions are fluoranthene ions.

26. The method of claim 16, wherein the step of transmitting a selected one of the reagent ions or the analyte ions includes applying a DC voltage to at least one ion transport optic, the amplitude and polarity of the DC voltage being chosen to allow transmission of the selected ions and block transmission of the non-selected ions.
